(19) United States
(12) Patent Application Publication
(10) Pub. No.: US 2014/0325578 A1
(43) Pub. Date: Oct. 30, 2014

(54) METHOD, DEVICE AND SYSTEM FOR CROSS-PLATFORM VIDEO FILE PLAYING

(71) Applicant: Tencent Technology (Shenzhen) Co., Ltd., Shenzhen (CN)

(72) Inventor: Zhutang HUANG, Shenzhen (CN)

(73) Assignee: Tencent Technology (Shenzhen) Co., Ltd., Shenzhen (CN)

(21) Appl. No.: 14/164,965

(22) Filed: Jan. 27, 2014

Related U.S. Application Data
(63) Continuation of application No. PCT/CN2013/088126, filed on Nov. 29, 2013.

(30) Foreign Application Priority Data
Apr. 28, 2013 (CN) 2013101560415

(51) Int. Cl. H04N 21/2343

(52) U.S. Cl. CPC H04N 21/234309
USPC 725/116

(57) ABSTRACT

A cross-platform video playing method, playing device and playing system is presented. The method includes the steps of receiving a shared video sent by a first terminal; detecting whether a video format of the shared video is consistent with a video format which is supported by a default video player on a second terminal; in case if it is detected that the video format of the shared video is inconsistent with the video format which is supported by the default video player on the second terminal, converting the shared video into a video media file that can be played by the default video player on the second terminal; and transmitting the video media file to the second terminal, such that the received video media file can be played directly by the default video player without having to perform video format conversion or installing a video player on the second terminal.

### CROSS-REFERENCE TO RELATED APPLICATIONS

This application is a continuation of PCT Application No. PCT/CN2013/088126, filed on Nov. 29, 2013, which claims priority to Chinese Patent Application No. 2013101560415, filed on Apr. 28, 2013, which is incorporated by reference in their entireties.

### FIELD OF THE TECHNOLOGY

The present disclosure pertains to the field of video file playing, and more particularly, a method, device and system for playing a video file in a cross-platform environment.

### BACKGROUND

Communication software enables people to send or transfer messages or files to each other. The messages or file may include texts, images and videos, etc. Different terminals from different manufacturers may run on different operating systems, and different terminals may install different types of default video players which support different video formats on the corresponding terminals. Consequently, videos from one terminal may not be able to play on another terminal due to different types of operating systems or different default video players.

The prior art solutions are to either convert the video format at the user end terminal in order to play a shared video from another terminal, or having to install the required default video player with consistent video format onto the user end terminal in order to play the shared video on the user end terminal. Either one of the above prior art solutions are both time consuming and cumbersome, let alone consuming the resources of the user terminal.

### SUMMARY

An object of the various embodiments of the present disclosure is to provide a cross-platform video playing method and a cross-platform video playing device which solve the problems of requiring to install a variety of video players on an existing terminal in order to play shared videos having video formats inconsistent with the video format of the default video player on the existing terminal.

An aspect of the disclosure discloses a cross-platform video playing method, including performing the steps of: receiving a shared video sent by a first terminal; detecting whether a video format of the shared video is consistent with a video format which is supported by a default video player on a second terminal. In case if it is detected that the video format of the shared video is inconsistent with the video format which is supported by the default video player on the second terminal, converting the shared video into a video media file that can be played by the default video player on the second terminal; and transmitting the video media file to the second terminal, such that the received video media file can be played by the default video player on the second terminal.

Another aspect of the disclosure discloses a cross-platform video playing device, comprises at least a processor operating in conjunction with a memory, and a plurality of units formed by hardware, software or both hardware and software, wherein the plurality of units may include: a detection unit which receives shared video sent by a first terminal, and detects whether a video format of the shared video is consistent with a video format which is supported by a default video player on a second terminal; a conversion unit which converts the shared video into a video media file that can be played by the default video player on the second terminal, in case if it is detected that the video format of the shared video is inconsistent with the video format which is supported by the default video player on the second terminal; and a transmission unit which transmits the video media file to the second terminal, such that the received video media file can be played by the default video player on the second terminal.

Still another aspect of the disclosure discloses a cross-platform video playing system, which may include: a server which receives shared video transmitted from a first terminal; the server detects whether a video format of the shared video is consistent with a video format which is supported by a default video player on a second terminal, in case if it is detected that the video format of the shared video is inconsistent with the video format which is supported by the default video player on the second terminal, the server converts the shared video into a video media file that can be played by the default video player on the second terminal; and the server transmits the video media file to the second terminal, such that the received video media file can be played by the default video player on the second terminal.

According to the various aspects of the present disclosure, the first terminal transmits a shared video to the server; and the server receives the shared video and detects whether the video format of the shared video is consistent with that supported by the default video player of the second terminal. If not, the server converts the shared video into a video media file with a video format that can be played by the default video player of the second terminal.

The server transmits the video media file (with video format converted to be consistent with the second terminal) to the second terminal so that a user may play the shared videos from the different terminals without having to convert the video format of the shared videos at the user end, and without a need of installing a corresponding video player which matches the video format of the shared video at the user end, thus increases user experience and does not consume the resources of the second terminal unnecessarily.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 illustrates an exemplary cross-platform video playing system, according to an embodiment of the present disclosure.

FIG. 2 is a flow chart illustrating an exemplary cross-platform video playing method, according to an embodiment of the present disclosure.

FIG. 3 is a flow chart illustrating an exemplary cross-platform video playing method, according to another embodiment of the present disclosure.

FIG. 4 illustrates an exemplary functional block diagram of a cross-platform video playing device, according to another embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features will be referenced back to the prior descriptions.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

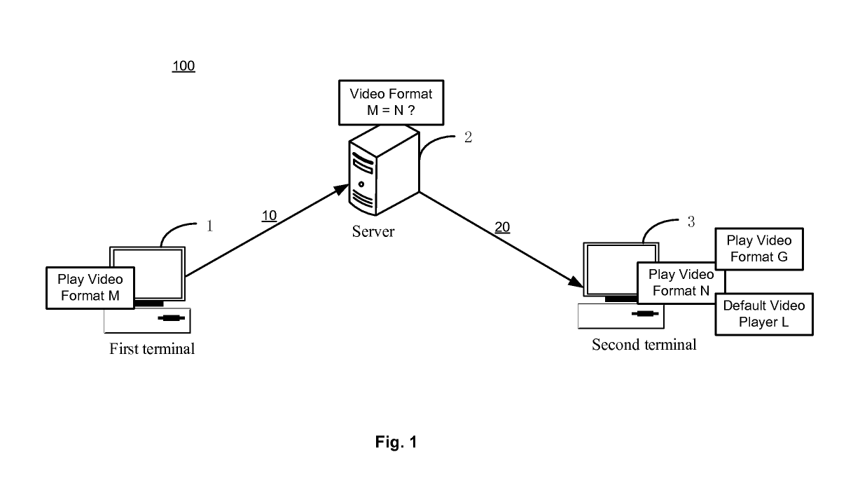

FIG. 1 illustrates an exemplary cross-platform video playing system (100), according to an embodiment of the present disclosure. As shown in FIG. 1, the cross-platform video playing system (100) may include at least a first terminal (1), a server (2) and a second terminal (3).

The first terminal (1) may transmit a shared video (10) to a server (2); and the server (2) may receive the shared video (10) and may detect whether a video format (M) of the shared video (10) is consistent with a video format (N) which is supported by a default video player (L) of the second terminal (3).

In case if it is detected by the server (2) that the video format (M) of the shared video (10) is inconsistent with the video format (N) which is supported by the default video player (L) on the second terminal (3), the server (2) may convert the shared video (10) into a video media file (20), and transmits the video media file (20) with a video format (N) that can be played by the default video player (L) on the second terminal (3).

In this regard, any shared video from any terminal (such as the first terminal (1)) may be played (after being converted by the server (3) as the received media file) by another terminal (such as the second terminal (3)), without the another terminal having to convert the video format of the shared video, under a condition that a suitable video player for the shared video may not be available for installation by the second terminal (3).

In another embodiment of the present disclosure, the converting of the shared video (10) into the video media file (20) may include: converting the shared video (10) into a time-continuous image media file according to one or more video frame of the shared video (10), or converting the shared video (10) into to the video media file (20) with the video format (N) that is supported by the default video player (L) on the second terminal (3).

Furthermore, the converting of the shared video (10) into the video media file (20) with the video format (N) that is supported by the default video player (L) on the second terminal (3) may include: converting the shared video into a video media file with one or more general video formats (G), such as the MP4 format.

For example, the default video player (L) on the second terminal (3) may run on one of the existing operating systems, such as MP4, Apple's IOS®, Google's Android®, Microsoft's WP7® and the like, which may support the one or more general video formats (G) (such as the MP4 format).

In this regard, the server (2) facilitates general video format (G) conversion on the shared video (10) into a video format (G) which may be supported by both the first terminal (1) as well as the second terminal (3).

Alternately, the shared video (10) may be converted into a video format (20) which is supported only by the default video player (L) on the second terminal (3), by acquiring the video format (N) that is supported by the default video player (L) on the second terminal (3).

Prior to the step of acquiring the video format (N) that is supported by the default video player (L) on the second terminal (3), the server (2) may acquire information of an operating system of the second terminal (3) when the second terminal (3) is being accessed, and utilizing the acquired information of the operating system to acquire the video format (N) supported by the default video player (L) on the second terminal (3).

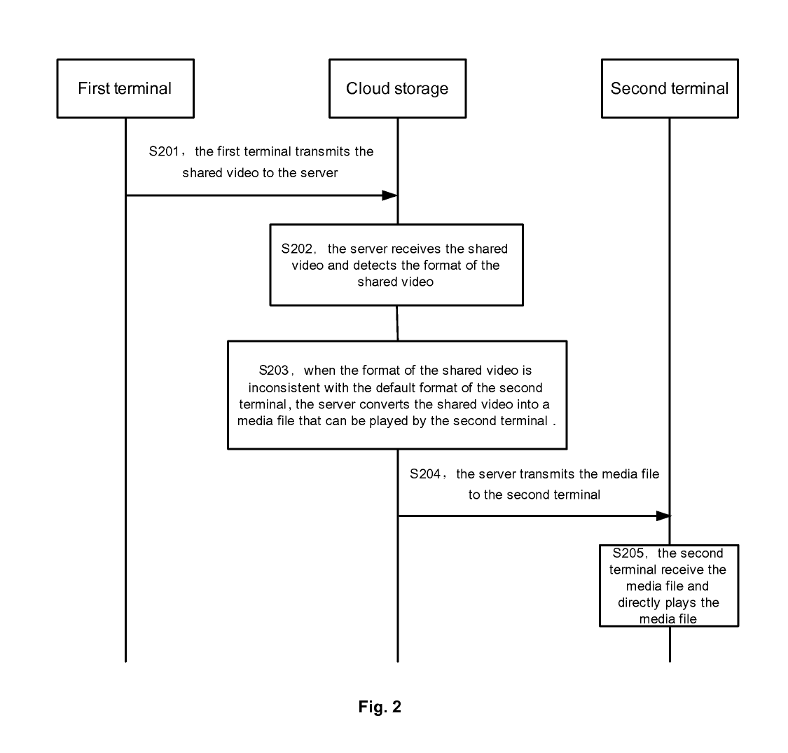

FIG. 2 is a flow chart illustrating an exemplary cross-platform video playing method, according to an embodiment of the present disclosure. The method may illustrate the exemplary steps or functions performed by the cross-platform video playing system (100) as previously described in FIG. 1. In this regard, FIG. 2 may refer back to the entities as previously described in FIG. 1.

In step S201, the first terminal (1) may transmit a shared video (10) to the server (2).

In the step S202, the server (2) may receive the shared video (10) and detects whether a video format (M) of the shared video (10) is consistent with a video format (N) which is supported by a default video player (L) on a second terminal (3).

It should be pointed out that default video players operating under different operating systems may correspondingly support different respective video formats in playing videos. For example, a default video player of an operating system A may support a video format of 3GP, and an operating system B may support a video format of RMVB.

After receiving the shared video (10) sent by the first terminal (1), the server (2) may detect whether the video format (M) of the shared video (10) is consistent with the video format (N) which is supported by the default video player (L) of the second terminal (3). If the video format (M) of the shared video (10) is consistent with the video format (N) which is supported by the default video player (L) on the second terminal (3) (in this case, 3GP or RMVB), the server (2) may forward the shared video (10) to the second terminal (3) to be played directly on the default video player (L), otherwise, the server (2) may enter into step S203.

In step S203, in case if it is detected that the video format (M) of the shared video (10) is inconsistent with the video format (N) which is supported by the default video player (L) on the second terminal (3), the server (2) may convert the shared video (10) into a video media file (20) that can be played by the default video player (L) on the second terminal (3).

The converting of the shared video (10) into the media file (20) may include: converting the shared video (10) into a time-continuous image media file according to one or more video frame of the shared video (10), or converting the shared video (10) into to the video media file (20) with the video format (N) that is supported by the default video player (L) on the second terminal (3).

The converting of the shared video (10) into the video media file (20) with the video format (N) that is supported by the default video player (L) on the second terminal (3) may alternately include the step of: converting the shared video (10) into a video media file (20) with a general video format (G).

For example, the default video player (L) on the second terminal (3) may run on one of the existing operating systems, such as MP4, Apple's IOS®, Google's Android®, Microsoft's WP7® and the like, which may support the one or more general video formats (such as the MP4 format).

In this regard, the server (2) may facilitate general video format (G) conversion on the shared video (10) into a video format (G) which is supported by both the first terminal (1) as well as the second terminal (3).

As described, the server (2) may simply convert the shared video (10) into the video media file (20) with the video format (N) that is supported only by the default video player (L) on the second terminal (3).

As an alternative embodiment of the present disclosure, prior to the step of converting the shared video (10) into the video media file (20) with the video format (N) that is supported only by the default video player (L) on the second terminal (3), the server (2) may first acquire the video format (N) supported by the default video player (L) of the second terminal (2).

As another alternative embodiment of the present disclosure, prior to the step of acquiring the video format that is supported by the default video player on the second terminal (3), when the second terminal (3) is being accessed, the server (2) may first acquire information of an operating system of the second terminal (3), and afterwards utilizing the acquired information of the operating system to acquire the video format (N) supported by the default video player (L) on the second terminal (3).

In step S204, the server (2) may transmit the video media (20) (which has been converted to video format (N)) to the second terminal (3).

In step S205, the second terminal (2) may simply receive the video media file (20) and using the default player (L) to directly play the video media file (20) without having to perform any video format conversion (i.e., from format M to format N) on the second terminal (2), under a condition that a suitable video player for the shared video may not be available for installation by the second terminal (3).

Accordingly, the above illustrated method improves end user's experience and does not consume additional resources on the second terminal (3) unnecessarily in installing another video player.

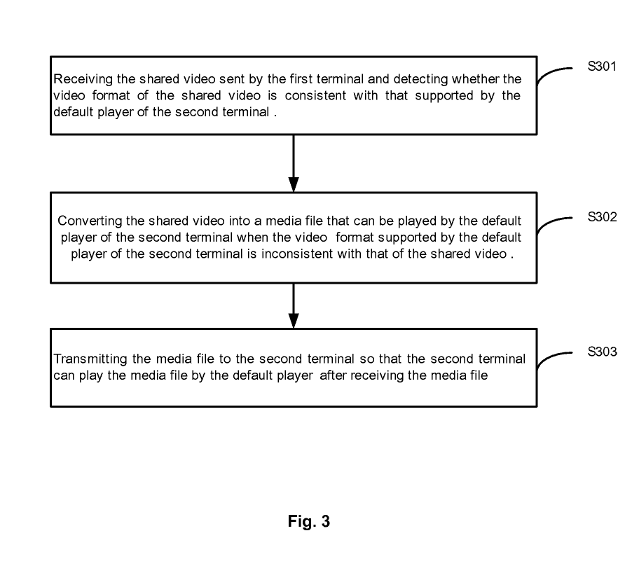

FIG. 3 is a flow chart illustrating an exemplary cross-platform video playing method, according to another embodiment of the present disclosure. FIG. 3 is similar to FIG. 2 in many similar ways.

The exemplary steps may be illustrated with the following steps:

In step S301, receiving a shared video sent by the first terminal and detecting whether a video format of the shared video is consistent with a video format which is supported by a default video player on a second terminal.

In the embodiment of the present disclosure, default video players of different operating systems support different video formats. For example, a default video player of an operating system A may support a video format of 3GP, and an operating system B may support a video format of RMVB.

After receiving the shared video sent by the first terminal (1), the server (2) may detect whether the video format of the shared video is consistent with the video format which is supported by the default video player of the second terminal (2). If the video format of the shared video is consistent with the video format which is supported by the default video player on the second terminal (in this case, 3GP or RMVB), the server (2) may send the shared video to the second terminal; otherwise, the server enters the step S302.

In step S302, in case if it is detected that the video format of the shared video is inconsistent with the video format which is supported by the default video player on the second terminal (3), the server (2) performs converting the shared video into a video media file that can be played by the default video player on the second terminal (3).

In the embodiment of the present disclosure, the converting of the shared video into the media file may include: converting the shared video into a time-continuous image media file according to one or more video frame of the shared video, or converting the shared video into to the video media file with the video format that is supported by the default video player on the second terminal (3).

The converting of the shared video into the video media file with the video format that is supported by the default video player on the second terminal may include: converting the shared video into a video media file with a general video format, or converting the shared video into the video media file with the video format that is supported only by the default video player on the second terminal.

As an alternative embodiment of the present disclosure, prior to the step of converting the shared video into the video media file with the video format that is supported only by the default video player on the second terminal, the method further include the step of: acquiring the video format that is supported by the default video player on the second terminal.

Alternately, prior to the step of acquiring the video format that is supported by the default video player on the second terminal, the method may include the step of: acquiring information of an operating system of the second terminal when the second terminal is being accessed, and utilizing the acquired information of the operating system to acquire the video format supported by the default video player on the second terminal.

In step S303, the server (2) may transmit the video media file to the second terminal (3) such that the received video media file can be played by the default video player on the second terminal.

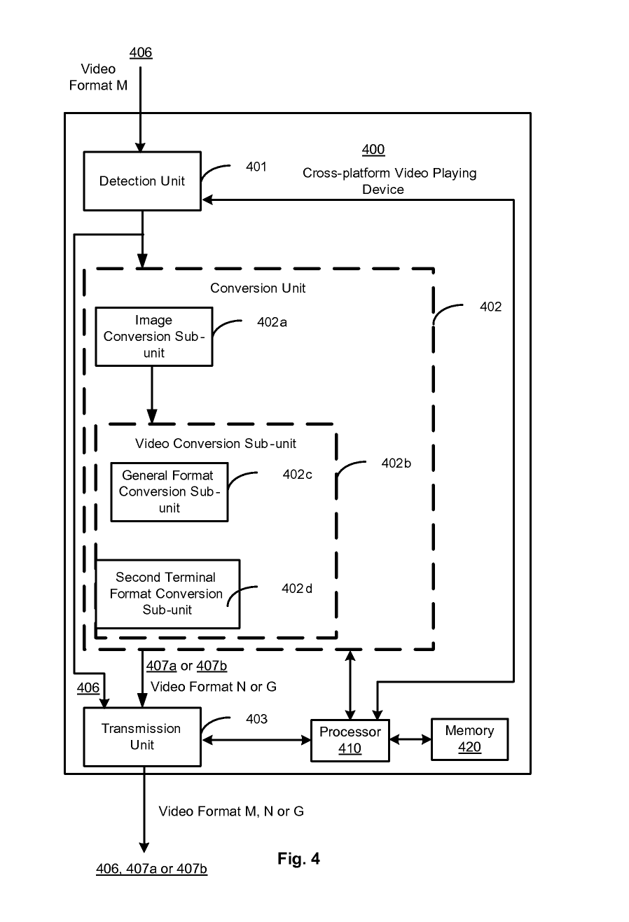

FIG. 4 illustrates an exemplary functional block diagram of a cross-platform video playing device (400), according to an embodiment of the present disclosure. The cross-platform video playing device (400) may be a server (such as the server (2) in FIG. 1), which may include at least a processor (410) operating in conjunction with a non-transitory memory (420), and at least a plurality of units (401-403) formed by hardware, software or both hardware and software. The plurality of units (401-403) is described in details as follows.

A detection unit (401) which receives shared video (406) sent by a first terminal (such as first terminal (1) in FIG. 1). The detection unit (401) may detect whether a video format (M) of the shared video (406) may be consistent with a video format which may be supported by a default video player on a second terminal (such as default video player (L) on the second terminal (3) in FIG. 1).

In case if the video format (M) of the shared video (406) is consistent with the video format which is supported by the default video player of the second terminal, the detection unit (401) may send or forward the shared video (407a) (in video format (M)) to the second terminal; otherwise, the detection unit transmits the shared video to a conversion unit 402 for processing.

A conversion unit (402) which converts the shared video (406) into a video media file that can be played by the default video player (e.g., video player L in FIG. 1) on the second terminal, in case that the video format (M) of the shared video (406) is inconsistent with the video format (N) which is supported by the default video player (L) on the second terminal.

The conversion unit (402) may include: an image conversion sub-unit (402a) which converts the shared video into a time-continuous image media file according to one or more video frame of the shared video, or the video conversion sub-unit (402b) which converts the shared video into to the video media file (407a) with the video format (N) that is supported by the default video player (L) on the second terminal.

Meanwhile, the video conversion sub-unit (402b) may include: a general format conversion sub-unit 402(c) which converts the shared video (406) into the video media file (407c) of general video format (G).

For example, the default video player (L) on the second terminal (3) may run on one of the existing operating systems, such as MP4, Apple's IOS®, Google's Android®, Microsoft's WP7® and the like, which may support the one or more general video formats (such as the MP4 format).

The video conversion sub-unit (402b) may include: a second terminal format conversion sub-unit (402d) which converts the shared video (406) into the video media file (407a) with the video format (N) that is supported only by the default video player (L) on the second terminal.

Prior to performing the conversion by the second terminal format conversion sub-unit (402d), the device (400) further includes: a second terminal format acquisition sub-unit which acquires the video format (N) that is supported by the default video player (L) on the second terminal.

In another alternative disclosure, prior to the second terminal format acquisition sub-unit performing the acquisition of the video format that is supported by the default video player on the second terminal, the device may further include: an operating system acquisition sub-unit which acquires information of an operating system of the second terminal when the second terminal is being accessed, and utilizing the acquired information of the operating system to acquire the video format supported by the default video player on the second terminal.

A transmission unit (403) which may transmit the video media file (407a) to the second terminal, such that the received video media file may be played by the default video player on the second terminal.

According to the embodiment of the present disclosure, the first terminal may transmit shared video (406) to a cross-platform video playing device (400) (i.e., disclosed as a server); and the server receives the shared video and detects whether the video format (M) of the shared video (406) is consistent with a video format (N) which is supported by a default video player on a second terminal, converts the shared video into a video media file that can be played by the default video player on the second terminal, in case that the video format of the shared video is inconsistent with the video format which is supported by the default video player on the second terminal, and transmits the video media file to the second terminal, such that the received video media file can be played by the default video player on the second terminal without converting the video format at the terminal side under a condition that no other video player may be installed.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive, ROM or flash memory. The computer-executable commands are used to enable a computer, server, a smart phone, a tablet or any similar computing device to accomplish the cross-platform video playing operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A cross-platform video playing method, comprising:
receiving a shared video sent by a first terminal;
detecting whether a video format of the shared video is consistent with a video format which is supported by a default player on a second terminal;
in case if it is detected that the video format of the shared video is inconsistent with the video format which is supported by the default video player on the second terminal, converting the shared video into a video media file that can be played by the default video player on the second terminal; and
transmitting the video media file to the second terminal, such that the received video media file can be played by the default video player on the second terminal.

2. The method according to claim 1, wherein the converting of the shared video into the video media file comprises:
converting the shared video into a time-continuous image media file according to one or more video frame of the shared video, or
converting the shared video into to the video media file with the video format that is supported by the default video player on the second terminal.

3. The method according to claim 2, wherein the converting of the shared video into the video media file with the video format that is supported by the default video player on the second terminal comprises:
converting the shared video into a video media file with a general video format, or
converting the shared video into the video media file with the video format that is supported only by the default video player on the second terminal.

4. The method according to claim 3, wherein prior to the step of converting the shared video into the video media file with the video format that is supported only by the default video player on the second terminal, comprises:
acquiring the video format that is supported by the default video player on the second terminal.

5. The method according to claim 4, wherein prior to the step of acquiring the video format that is supported by the default video player on the second terminal, comprises:
acquiring information of an operating system of the second terminal when the second terminal is being accessed, and utilizing the acquired information of the operating system to acquire the video format supported by the default video player on the second terminal.

6. A cross-platform video playing device, comprising at least a processor operating in conjunction with a memory, and a plurality of units formed by hardware, software or both hardware and software, wherein the plurality of units comprise:
a detection unit which receives shared video sent by a first terminal, and detects whether a video format of the shared video is consistent with a video format which is supported by a default video player on a second terminal;
a conversion unit which converts the shared video into a video media file that can be played by the default video player on the second terminal, in case if it is detected that the video format of the shared video is inconsistent with the video format which is supported by the default video player on the second terminal; and
a transmission unit which transmits the video media file to the second terminal, such that the received video media file can be played by the default video player on the second terminal.

7. The device according to claim 6, wherein the conversion unit comprises:
an image conversion sub-unit which converts the shared video into a time-continuous image media file according to one or more video frame of the shared video; or
a video conversion sub-unit which converts the shared video into to the video media file with the video format that is supported by the default video player on the second terminal.

8. The device according to claim 7, wherein the video conversion sub-unit comprises:
a general format conversion sub-unit which converts the shared video into a video media file with a general video format; or
a second terminal format conversion sub-unit which converts the shared video into the video media file with the video format that is supported only by the default video player on the second terminal.

9. The device according to claim 8, wherein prior to performing the conversion by the second terminal format conversion sub-unit, the device further comprises:
a second terminal format acquisition sub-unit which acquires the video format that is supported by the default video player on the second terminal.

10. The device according to claim 9, wherein prior to the second terminal format acquisition sub-unit performing the acquisition of the video format that is supported by the default video player on the second terminal, the device further comprises:
an operating system acquisition sub-unit which acquires information of an operating system of the second terminal when the second terminal is being accessed, and utilizing the acquired information of the operating system to acquire the video format supported by the default video player on the second terminal.

11. A cross-platform video playing system, comprising:
a server which receives shared video transmitted from a first terminal;
the server detects whether a video format of the shared video is consistent with a video format which is supported by a default video player on a second terminal,
in case if it is detected that the video format of the shared video is inconsistent with the video format which is supported by the default video player on the second terminal, the server converts the shared video into a video media file that can be played by the default video player on the second terminal; and
the server transmits the video media file to the second terminal, such that the received video media file can be played by the default video player on the second terminal.

12. The system according to claim 11, wherein the converting of the shared video into the video media file comprises:
the shared video into a time-continuous image media file according to one or more video frame of the shared video, or
the server converts the shared video into to the video media file with the video format that is supported by the default video player on the second terminal.

13. The system according to claim 12, wherein the server converts the video into the time-continuous image media file according to the video frame of the shared video, comprises:
the server converts the shared video into a video media file with a general video format, or
converting the shared video into the video media file with the video format that is supported only by the default video player on the second terminal.

14. The system according to claim 13, wherein prior to converting the shared video into the video media file with the video format that is supported only by the default video player on the second terminal: the server acquires the video format that is supported by the default video player on the second terminal.

15. The system according to claim 14, wherein prior to the acquiring of the video format that is supported by the default video player on the second terminal: the server acquires information of an operating system of the second terminal when the second terminal is being accessed, and utilizing the acquired information of the operating system to acquire the video format supported by the default video player on the second terminal.
